(19) United States
(12) Patent Application Publication
(10) Pub. No.: US 2010/0293104 A1
(43) Pub. Date: Nov. 18, 2010

(54) SYSTEM AND METHOD FOR FACILITATING SOCIAL COMMUNICATION

(76) Inventors: Stefan Olsson, Lund (SE); Jonas Andersson, Menlo Park, CA (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/464,932

(22) Filed: May 13, 2009

(51) Int. Cl. G06Q 99/00; G06Q 50/00; G06F 7/06; G06F 17/30

(52) U.S. Cl. 705/319; 707/E17.107

(57) ABSTRACT

To facilitate social interaction through chat rooms, described are a system and a method for identifying and/or creating chat rooms that correspond to an operational context of a user's electronic device. Various conditions may be monitored and evaluated to identify a correlation between the states of two conditions. Upon such identification, a search may be made for a corresponding chat room. If a corresponding chat room is found, an offer to enter the chat room may be offered to the user. If a corresponding chat room is not identified, the user may be offered an opportunity to create a chat room for a topic corresponding to the correlating conditions.

### TECHNICAL FIELD OF THE INVENTION

The technology of the present disclosure relates generally to social communication accessed using electronic device and, more particularly, to a system and method for identifying and creating chat rooms based on operational context of a user's electronic device.

### BACKGROUND

Internet chat rooms (also referred to as social meeting sites and message boards) have become a popular way for people to exchange thoughts about various topics. Typically, users may post written comments relating to a chat room's designated topic. Pictures and audio visual content also may be posted on some chat room sites. Other users may view these posts and make responsive posts.

These types of forums provide avenues to discuss wide ranges of topics, such as a music artist's new song, movies, politics, and so forth. However, users must search to identify chat rooms of interest and/or create their own chat rooms if a chat room to the liking of the user cannot be identified.

### SUMMARY

To facilitate social interaction through chat rooms, the present disclosure describes a system and method for identifying and/or creating chat rooms that correspond to an operational context of a user's electronic device. Various conditions may be monitored and evaluated to identify a correlation between the states of two conditions. Upon such identification, a search may be made for a corresponding chat room. If a corresponding chat room is found, an offer to enter the chat room may be offered to the user. If a corresponding chat room is not identified, the user may be offered an opportunity to create a chat room for a topic corresponding to the correlating conditions.

According to one aspect of the disclosure, an electronic device includes communications circuitry configured to access social meeting sites over the Internet; and a control circuit configured to monitor data inputs related to operational context of the electronic device, identify a correlation between at least two of the data inputs, and identify a topic for a chat room discussion from the correlated data inputs.

According to one embodiment of the electronic device, the control circuit is further configured to search the social meeting sites for a chat room pertaining to the topic.

According to one embodiment of the electronic device, if a chat room pertaining to the topic is found, the control circuit is further configured to offer a user of the electronic device an opportunity to join the found chat room.

According to one embodiment of the electronic device, if a chat room pertaining to the topic is not found, the control circuit is further configured to offer a user of the electronic device an opportunity to start a chat room for the topic.

According to one embodiment of the electronic device, at least one data input is a media player input and input data from the media player input relates to audiovisual content played by a media player of the electronic device.

According to one embodiment of the electronic device, the played content is a song and the input data from the media player input is at least one of a name of the song, an artist that recorded the song, or a genre of the song.

According to one embodiment of the electronic device, the played content is a television show or a movie and the input data from the media player input is at least one of a name of the show or movie, an actor that appears in the show or movie, or a genre of the show or movie.

According to one embodiment of the electronic device, at least one data input is a location input and input data from the location input relates to location of the electronic device.

According to one embodiment of the electronic device, the input data from the location input is specified in terms of at least one of a city, a place within a city, a state or a province, or a country.

According to one embodiment of the electronic device, at least one data input is a clock and calendar input and data from the clock and calendar input relates to at least one of a recurring calendar event or a user scheduled calendar event.

According to one embodiment of the electronic device, at least one data input is a weather input and data from the weather input relates to at least one of a temperature or a type of weather.

According to one embodiment of the electronic device, the data from the weather input is provided by a service via the communication circuitry.

According to one embodiment of the electronic device, at least one data input is a movement input and data from the movement input relates to at least one of movement or orientation of the electronic device.

According to one embodiment of the electronic device, at least one data input is a chat room input and data from the chat room input relates to topics available for discussion on existing chat rooms.

According to another aspect of the disclosure, a method of facilitating social interaction using an electronic device that accesses social meeting sites over the Internet includes monitoring data inputs related to operational context of the electronic device; identifying a correlation between at least two of the data inputs; and identifying a topic for a chat room discussion from the correlated data inputs.

According to one embodiment, the method further includes searching the social meeting sites for a chat room pertaining to the topic.

According to one embodiment of the method, if a chat room pertaining to the topic is found, offering a user of the electronic device an opportunity to join the found chat room.

According to one embodiment of the method, if a chat room pertaining to the topic is not found, offering a user of the electronic device an opportunity to start a chat room for the topic.

According to one embodiment of the method, the data inputs include a data input from at least one of a media player input, a location input, a clock and calendar input, a weather input, and a movement input.

According to one embodiment of the method, at least one data input is a chat room input and data from the chat room input relates to topics available for discussion on existing chat rooms.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram of a communications system in which a mobile electronic device may operate;

FIG. 2 is a schematic block diagram of an exemplary electronic device;

FIG. 3 is a schematic block diagram of inputs to a context aware engine component of a chat room function; and

FIG. 4 is a flow chart representing an exemplary method of facilitating social interaction through chat rooms.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

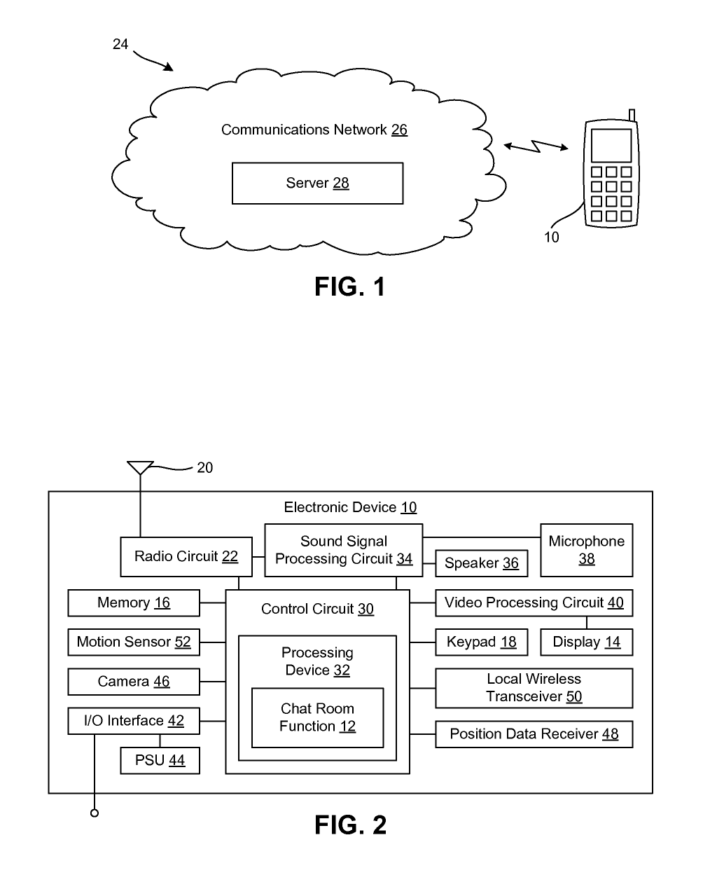

Referring initially to FIGS. 1 and 2, shown is an electronic device 10 in the exemplary form of a mobile telephone. The electronic device 10 includes a chat room function 12 that is configured to facilitate social interaction through websites that support the exchange of text and/or other content among two or more users. Additional details and operation of the chat room function 12 will be described in greater detail below. The chat room function 12 may be embodied as executable instructions (e.g., code) that is resident in and executed by the electronic device 10. In one embodiment, the chat room function 12 may be one or more programs that are stored on a computer readable medium. The chat room function 12 may be a stand-alone software application or may form a part of a software application that carries out additional tasks related to the electronic device 10.

Also, through the following description, exemplary techniques for facilitating social interaction over a network are described. It will be appreciated that through the description of the exemplary techniques, steps that may be carried out in part by executing software are presented. The described steps are the foundation from which a programmer of ordinary skill in the art may write code to implement the described functionality. As such, a computer program listing is omitted for the sake of brevity. However, the described steps may be considered a method that the corresponding device is configured to carry out. Also, while the chat room function 12 is implemented in software in accordance with an embodiment, such functionality could also be carried out via dedicated hardware or firmware, or some combination of hardware, firmware and/or software.

The electronic device 10 may include a display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 16 of the electronic device 10. The display 14 may be used to present images, video and other graphics to the user, such as photographs, mobile television content, Internet pages, and video associated with games.

A keypad 18 and/or touch screen functionality of the display may provide for a variety of user input operations. For example, the keypad 18 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Also, the display 14 and keypad 18 may be used in conjunction with one another to implement soft key functionality.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 16, executing applications to allow user interaction with the data, displaying video and/or image content associated with the data, outputting audio sounds associated with the data, and so forth. In addition, the electronic device 10 may access and interact with Internet web pages including, but not limited to, performing Internet searches.

In the exemplary embodiment, the communications circuitry may include an antenna 20 coupled to a radio circuit 22. The radio circuit 22 includes a radio frequency transmitter and receiver for transmitting and receiving signals via the antenna 20.

The radio circuit 22 may be configured to operate in a mobile communications system 24. Radio circuit 22 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, etc., as well as advanced versions of these standards or any other appropriate standard. It will be appreciated that the electronic device 10 may be capable of communicating using more than one standard. Therefore, the antenna 20 and the radio circuit 22 may represent one or more than one radio transceiver.

The system 24 may include a communications network 26 having a server 28 (or servers) for managing calls placed by and destined to the electronic device 10, transmitting data to and receiving data from the electronic device 10 and carrying out any other support functions. The server 28 communicates with the electronic device 10 via a transmission medium. The transmission medium may be any appropriate device or assembly, including, for example, a communications base station (e.g., a cellular service tower, or “cell” tower), a wireless access point, a satellite, etc. The network 26 may support the communications activity of multiple electronic devices 10 and other types of end user devices. As will be appreciated, the server 28 may be configured as a typical computer system used to carry out server functions and may include a processor configured to execute software containing logical instructions that embody the functions of the server 28 and a memory to store such software.

The electronic device 10 may include a primary control circuit 30 that is configured to carry out overall control of the functions and operations of the electronic device 10. The control circuit 30 may include a processing device 32, such as a central processing unit (CPU), microcontroller or microprocessor. The processing device 32 executes code stored in a memory (not shown) within the control circuit 30 and/or in a separate memory, such as the memory 16, in order to carry out operation of the electronic device 10. For instance, the memory within the control circuit 30 and/or the memory 16 may store executable code that embodies the chat room function 12 and the processing device 32 may execute that code so that the control circuit 30 is configured to implement the functions of the chat room function 12. The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory for long term data storage and a volatile memory that functions as system memory for the control circuit 30. The memory 16 may exchange data with the control circuit 30 over a data bus. Accompanying control lines and an address bus between the memory 16 and the control circuit 16 also may be present.

The electronic device 10 further includes a sound signal processing circuit 34 for processing audio signals transmitted by and received from the radio circuit 22. Coupled to the sound processing circuit 34 are a speaker 36 and a microphone 38 that enable a user to listen and speak via the electronic device 10. The radio circuit 22 and sound processing circuit 34 are each coupled to the control circuit 30 so as to carry out overall operation. Audio data may be passed from the control circuit 30 to the sound signal processing circuit 34 for playback to the user. The audio data may include, for example, audio data from an audio file stored by the memory 16 and retrieved by the control circuit 30, or received audio data such as in the form of voice communications or streaming audio data from a mobile radio service. The sound processing circuit 34 may include any appropriate buffers, decoders, amplifiers and so forth.

The display 18 may be coupled to the control circuit 30 by a video processing circuit 40 that converts video data to a video signal used to drive the display 14. The video processing circuit 40 may include any appropriate buffers, decoders, video data processors and so forth. The video data may be generated by the control circuit 30, retrieved from a video file that is stored in the memory 16, derived from an incoming video data stream that is received by the radio circuit 22 or obtained by any other suitable method.

The electronic device 10 may further include one or more input/output (I/O) interface(s) 42. The I/O interface(s) 42 may be in the form of typical mobile telephone I/O interfaces and may include one or more electrical connectors. The I/O interfaces 42 may form one or more data ports for connecting the electronic device 10 to another device (e.g., a computer) or an accessory (e.g., a personal handsfree (PHF) device) via a cable. Further, operating power may be received over the I/O interface(s) 42 and power to charge a battery of a power supply unit (PSU) 44 within the electronic device 10 may be received over the I/O interface(s) 42. The PSU 44 may supply power to operate the electronic device 10 in the absence of an external power source.

The electronic device 10 also may include various other components. For instance, a camera 46 may be present for taking digital pictures and/or movies. Image and/or video files corresponding to the pictures and/or movies may be stored in the memory 16.

A position data receiver 48, such as a global positioning system (GPS) receiver, may be involved in determining the location of the electronic device 10. In exemplary embodiments, location determination may be made by the electronic device 10 or in conjunction with an assistance server using assisted GPS (AGPS).

A local wireless transceiver 50, such as an infrared transceiver and/or an RF transceiver (e.g., a Bluetooth chipset) may be used to establish communication with a nearby device, such as an accessory (e.g., a PHF device), another mobile radio terminal, a computer or another device.

Movement and orientation of the electronic device 10 may be tracked using motion sensors 52, such as accelerometers,

The chat room function 12 now will be described in greater detail. The conventional approach to finding a chat room is to search for chat rooms a specific topic of interest that is manually entered by the user. For example, the user may key in the name of a music artist or the title of a music track (e.g., song) to identify forums that exist for the discussion of the topic. Alternatively, the user may manually create a forum.

In some instances, a user may be interested in exchanging thoughts about a topic as the topic relates to other information, such as the location of the user or the home city, state, or nation of the user. In this manner, the social interaction through the forum is connected to the additional information (e.g., a geographical place). Other possible forms of additional information include, but are not limited to, weather conditions, cyclic or recurring events (e.g., the turning of a New Year, election cycles, night and day cycles, etc.).

The chat room function 12 provides a mechanism to identify relationships between two (or more) monitored conditions. When a correlation between the conditions is identified, a search may be made for a corresponding chat room. If a corresponding chat room is found, an offer may be made to the user to enter the chat room. If a chat room is not found, or is not of interest to the user, an offer may be made to the user to create a new chat room.

The chat room function 12 may monitor for the correlations in the background. In this manner, the user need not have to consciously draw a connection between two conditions (e.g., playback of a particular song and the impeding arrival of certain holiday). Also, the user need not “leave” consumption of content (e.g., by stopping playback of the content) to employ a search tool to find a social interaction forum related to the content.

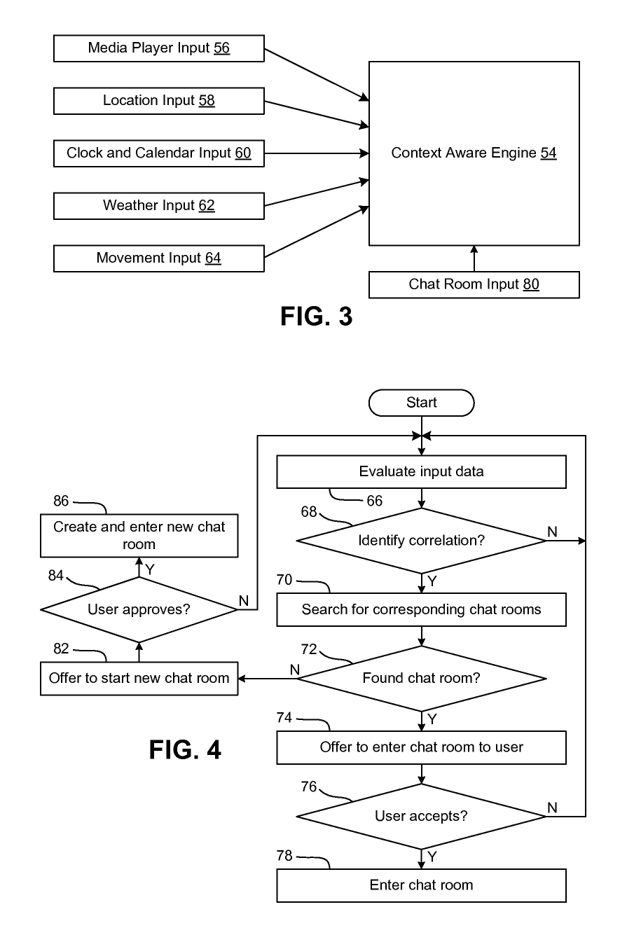

With additional reference to FIG. 3, the chat room function 12 may include a context aware engine 54 that performs monitoring of various data inputs and identifies correlations between the inputs that may be combined to form a topic of possible chat room interest to the user. In the illustrated embodiment, the data inputs may include a media player input 56, a location input 58, a clock and calendar input 60, a weather input 62, and a movement input 64.

Data supplied to the context aware engine 54 from the media player input 56 may include information relating to audiovisual content (e.g., songs, music videos, television shows, movies, etc.) that is being consumed by the user. The data may be obtained from a media player that is executed by the control circuit 30 and be in the form of content attributes. The content attributes may be obtained from metadata associated with the content or a database. As an example, in the case of a song, the data may include the name of the song, the artist that recorded the song, the type of music (e.g., a genre for the song, such as rock, pop, rap, country, classical, etc.), an era for the song (e.g., a decade in which the song was released), and so forth. Each one of these data items may represent a condition that is monitored by the context aware engine. As another example, if the audio visual content is a movie, the data may include the name of the movie, the names of popular actors that are in the movie, the type of movie (e.g., a genre for movie, such as comedy, horror, action, drama, etc.), a setting for the movie (e.g., a city name, a country name, etc.), and so forth.

Data supplied by the location input 58 may include a position of the electronic device 10. The position may be ascertained using GPS or AGPA, for example. Other position locating techniques may be possible, such as connection to a network access point having a known location. The raw location may be converted to location designators that correspond to increasing geographic area, such as the name of the city in which the electronic device 10 is located, the name of province or state, and the name of the country. Also, in some situations, a more specific location designator may be ascertained to identify location with respect to a place. Such places may include, for example, an airport or train terminal, a college campus, a neighborhood within a city, the user's home or place of work, and so forth.

Data supplied by the clock and calendar input may include information about the current time and about events. The events may be events that are scheduled by the user, such as meetings, birthdays of relatives or friends, travel plans, and so forth. Other events may include common cyclical or recurring events for the current location or a user specified location, such as secular and/or religious holidays, elections, daytime hours and nighttime hours, etc.

Data supplied by the weather input 62 may include information about current weather conditions for the current location or a user specified location. In one embodiment, the weather condition information may be supplied by a weather service hosted by a server that is accessed by the context aware function 54. Exemplary weather condition information items may include temperature, type of weather (e.g., sunny, overcast, rain, snow, wind, fog, etc.), and so forth.

Data supplied by the movement input 64 may originate from the motion sensors 52 and may be indicative of movement of the electronic device 10. The movement data may indicate whether the user is or has been walking, standing or sitting in a relatively stationary manner, and so forth.

The context aware engine 54 also may use items of user demographic information as additional input data when identifying correlations that may lead to chat room topics. User demographics may include a home city, state, and/or country of the user, an age of the user, a gender of the user, a collage or school attended by the user, and other items of personal information.

With additional reference to FIG. 4, illustrated are logical operations to implement an exemplary method of identifying social interaction sites based on operational context of the electronic device 10. The exemplary method may be carried out by executing an embodiment of the chat room function 12, for example. Thus, the flow chart of FIG. 4 may be thought of as depicting steps of a method carried out by the electronic device 10. Although FIG. 4 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may start in block 66 where the input data from the various inputs 56-64 is evaluated. As indicated evaluating the data may include identifying correlations between data items that may form a topic of interest for social interaction through an Internet website or other platform.

The analysis of block 66 may include determining if a correlation exists between data values from a predetermined pair data input categories and/or a user specified pair of data input categories. For instance, if the user is watching a movie, the pair of data input categories may include the lead male actor of the movie and the city in which the electronic device 10 is located.

As will be appreciated, the number of possible pairs of data input categories is numerous. Some exemplary pairs will be presented, but it will be understood that the described examples are not exhaustive. In one exemplary pair, a first data category for the pair may be any data value associated with played audiovisual content (e.g., the song name, song genre, or song artist, or movie or show name, actor name, movie or show genre, movie or show setting, etc.) and a second data category for the pair may be location (e.g., current location in terms of city, state or province, country, or area within a city, or user specified location from the demographic profile). In another exemplary pair, a first data category for the pair may be any data value associated with played audiovisual content and a second data category for the pair may be one of movement, time of day, weather condition, or recurring event.

In another exemplary pair, a first data category for the pair may be a calendar event (e.g., a user-specified appointment) and a second data category for the pair may be one of time of day, weather condition, or location. In another exemplary pair, a first data category for the pair may be a recurring calendar event (e.g., a predetermined recurring event or a user-specified occasion such as a birthday or anniversary) and a second data category for the pair may be actual date and/or time. This exemplary pair may lead to the identification of the approach, the occurrence or the passing of a recurring event so that the user may have a timely opportunity to discuss the corresponding topic through an electronic social interaction platform.

It will be further appreciated that more than two data values may be evaluated against each other to identify a potential social interaction topic.

In block 68, a determination may be made as to whether the evaluation of any of the pairs of data values result in a correlation that may form a topic of interest for social interaction through an Internet website or other platform. Some types of correlations may be directed to identifying the general activity in which the user engaged, as this may be indicative of a suitable topic for social interaction. For instance, if the user is listening to music at an airport, the context aware engine 54 may conclude that the user is waiting for an airplane. From this information, some potential topics for discussion may be related to air travel, restricted use of electronic devices on aircraft, the genre of the played music and cities known for such music, and so forth.

As another example, if a user a watching a movie or television show with a famous actor and the user is in a major city, the context aware engine may identify a correlation between the actor's name and the city. From this information, some potential topics for discussion may be related to visits to the city by the actor, persons who live in the city and are fans of the actor, and so forth.

As yet another example, the nearing of a recurring event may result in the identification of a correlation between the current time or date and the event from the calendar. It will be appreciated that the identification of this correlation may be automated and need not rely on the memory of the user. In one example, the nearing of a spouse's birthday may result in a topic related to birthday gifts or romantic restaurants.

In another example, the location of the electronic device 10 may be used by itself or in combination with other data values to identify possible topics for social interaction. For example, if the location is a city, possible topics are local sports teams, local restaurants, local news and so forth. As another example, if the calendar indicates that local elections for the city are nearing, a possible topic may be local politics and candidates for elected office.

In another example, the user may be listening to music and a temperature value indicates that it is cold outside. Under this set of circumstances, the context aware engine may identify a correlation between music and temperature. As a result, a possible topic may be songs that make me feel warm (e.g., songs that relate to a “beach lifestyle”).

In still another example, the user may have a meeting scheduled for 12:00 (noon). The context aware engine may identify a correlation between the time of the meeting and events that typically occur at that time. In this instance, the common event may be lunch and, therefore, a possible topic may be the question of why people schedule meetings during lunchtime.

If no correlation is identified in block 68, the logical flow may repeat until a correlation is identified. If a correlation is identified in block 68, the logical flow may proceed to block 70. In block 70, a search may be made for chat rooms that correspond to the correlations and/or topics that are determined in the prior steps. In block 72, a determination may be made as to whether any chat rooms that correspond to correlations and/or topics have been found in the search of block 70. If a positive determination is made in block 72, the logical flow may proceed to block 74 where the user may be asked whether he or she is interested in participating in the found chat room. The offer to participate in the chat room may be made by on-display menu option, for example. If, in block 76, the user accepts to offer to join the chat room, the logical flow may proceed to block 78 where the electronic device 10 uses appropriate interface software (e.g., an Internet browser) to join the chat room. If a negative determination is made in block 76, the logical flow may return to block 66 for further evaluation of data inputs.

In other embodiments, some of the functions of blocks 66, 68, 70 and 72 may be partially reversed and/or integrated with one another. For instance, a search may be made of available chat rooms that have a relationship to the current location of the electronic device 10. Other topical features of the chat rooms related to the location may be ascertained, such as attributes of audiovisual content, weather, sports, and so forth. Then, a determination may be made as to whether any content consumed by the user, any calendar events, any user interaction with the electronic device 10, or any other data input has a relationship to the topical features of the identified chat rooms. As an example, a chat room may be found that is for the user's city and for a particular music band. If the user plays music by that band, a relationship between user activity (the consumption of content) and an existing chat room may be identified.

Therefore, some embodiments may include scanning currently active chat rooms for topics being discussed by the chat room participants. Then is a correlation may be made to data inputs to the context aware engine, the user may be made aware that the chat room exists. In addition, even if the topics of active chat rooms do not have correlation to the data inputs to the context aware engine, the existing chat room topics may be used in combination with one or more data inputs to suggest a new chat room topic to the user as described more fully below. As a result, existing chat room topics may be considered as one of the data inputs to the context aware engine 54 in the form of a chat room topic input 80 (FIG. 3).

Following a negative determination is made in block 72, the logical flow may proceed to block 82. In block 82, the user may be offered the opportunity to start a chat room for a topic that stems from the correlation identified in block 68. The topic may be displayed to the with a menu choice to start the chat room. In block 84, if the user declines to start a chat room for the topic, the logical flow may return to block 66. If the user accepts the opportunity to start the chat room, the logical flow may proceed to block 86 where the electronic device 10 uses appropriate interface software (e.g., an Internet browser) to start the chat room. An existing platform, such as a website that hosts chat rooms, may be used in conjunction with creating the chat room.

The foregoing techniques use automated monitoring of data inputs related to operational activity of an electronic device 10, and possibly external factors (e.g., recurring events, weather conditions, active chat room topics, etc.) to identify relationships among the data inputs that may form the basis for a chat room topic. Then existing chat rooms that correspond to the topic may be identified. If no chat room exists for the topic, a chat room may be created. As a result, the techniques facilitate social interaction with minimal effort by the user. In some instances, an existing chat room of interest may be entered with few user actions (e.g., as little as one user input, such as a mouse click or a touch screen tap) or a new chat room may be created and entered with few user actions (e.g., as little as one user input, such as a mouse click or a touch screen tap).

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
communications circuitry configured to access social meeting sites over the Internet; and
a control circuit configured to monitor data inputs related to operational context of the electronic device, identify a correlation between at least two of the data inputs, and identify a topic for a chat room discussion from the correlated data inputs.

2. The electronic device of claim 1, wherein the control circuit is further configured to search the social meeting sites for a chat room pertaining to the topic.

3. The electronic device of claim 2, wherein if a chat room pertaining to the topic is found, the control circuit is further configured to offer a user of the electronic device an opportunity to join the found chat room.

4. The electronic device of claim 2, wherein if a chat room pertaining to the topic is not found, the control circuit is further configured to offer a user of the electronic device an opportunity to start a chat room for the topic.

5. The electronic device of claim 1, wherein at least one data input is a media player input and input data from the media player input relates to audiovisual content played by a media player of the electronic device.

6. The electronic device of claim 5, wherein the played content is a song and the input data from the media player input is at least one of a name of the song, an artist that recorded the song, or a genre of the song.

7. The electronic device of claim 5, wherein the played content is a television show or a movie and the input data from the media player input is at least one of a name of the show or movie, an actor that appears in the show or movie, or a genre of the show or movie.

8. The electronic device of claim 1, wherein at least one data input is a location input and input data from the location input relates to location of the electronic device.

9. The electronic device of claim 8, wherein the input data from the location input is specified in terms of at least one of a city, a place within a city, a state or a province, or a country.

10. The electronic device of claim 1, wherein at least one data input is a clock and calendar input and data from the clock and calendar input relates to at least one of a recurring calendar event or a user scheduled calendar event.

11. The electronic device of claim 1, wherein at least one data input is a weather input and data from the weather input relates to at least one of a temperature or a type of weather.

12. The electronic device of claim 11, wherein the data from the weather input is provided by a service via the communication circuitry.

13. The electronic device of claim 1, wherein at least one data input is a movement input and data from the movement input relates to at least one of movement or orientation of the electronic device.

14. The electronic device of claim 1, wherein at least one data input is a chat room input and data from the chat room input relates to topics available for discussion on existing chat rooms.

15. A method of facilitating social interaction using an electronic device that accesses social meeting sites over the Internet; comprising:
monitoring data inputs related to operational context of the electronic device;
identifying a correlation between at least two of the data inputs; and
identifying a topic for a chat room discussion from the correlated data inputs.

16. The method of claim 15, further comprising searching the social meeting sites for a chat room pertaining to the topic.

17. The method of claim 16, wherein if a chat room pertaining to the topic is found, offering a user of the electronic device an opportunity to join the found chat room.

18. The method of claim 16, wherein if a chat room pertaining to the topic is not found, offering a user of the electronic device an opportunity to start a chat room for the topic.

19. The method of claim 15, wherein the data inputs include a data input from at least one of a media player input, a location input, a clock and calendar input, a weather input, and a movement input.

20. The method of claim 15, wherein at least one data input is a chat room input and data from the chat room input relates to topics available for discussion on existing chat rooms.
